(19) United States
(12) Patent Application Publication
(10) Pub. No.: US 2006/0054663 A1
(43) Pub. Date: Mar. 16, 2006

(54) Method for producing a connection

(75) Inventor: Stefan Schwarz, Lunen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER, STUTTGART (DE)

(21) Appl. No.: 10/523,812

(22) PCT Filed: Jul. 19, 2003
(86) PCT No.: PCT/EP03/07910

§ 371 Date: Aug. 25, 2005

(30) Foreign Application Priority Data
Aug. 7, 2002 (DE) 102 36 132.0

(51) Int. Cl. B23K 20/12; B23K 31/02

(52) U.S. Cl. 228/115

(57) ABSTRACT

A method for making a joint between an initially closed tubular member and a hollow component includes the steps of using a fluid under high pressure acting on walls of the tubular member and component in a joint area to form at least one common indentation on the walls of the tubular member and of the component and using the high-pressure fluid to widen the tubular member in the joint area to form a non-circular cross-section.

### BACKGROUND AND SUMMARY OF THE INVENTION

The invention relates to a method for making a joint.

A method making a joint is disclosed in DE 196 53 509 A1. A joining technique is described therein for a frame of a motor vehicle body which is based on the internal high-pressure shaping of a hollow tubular member. In this technique a connection is formed on the hollow tubular member in a branch of a corresponding high internal pressure forming tool and is pressed against a connecting portion set frictionally in the branch by the high internal pressure. Bulges formed in the part of the workpiece in the joint area of the tool are also formed to the same shape as a result of the high internal pressure, so that an interlocking joint is formed between the tubular member and the joint part. However, with regard to forces attacking the junction part radially and/or axially, this joint is not rotation resistant on the one hand nor is it especially separation-resistant on the other.

The object of the invention is to improve a method making a joint such that a separation-resistant and torsion-resistant joint is created between a tubular section and a hollow component.

The object is achieved using a method that includes making a joint between an initially closed tubular member and a hollow component includes the steps of (1) using a fluid under high pressure acting on walls of the tubular member and component in a joint area to form at least one common indentation on the walls of the tubular member and of the component and (2) using the high-pressure fluid to widen the tubular member in the joint area to form a non-circular cross-section.

With the combined indentation of both the tubular section and the component, a virtually inseparable axial form lock between the two parts is achieved, so that safety against the separation of the component is largely assured. Security against rotation is achieved by converting the circular cross section of the tubular section to a non-circular one, for example oval or polygonal cross section, by way of the high internal pressure, so that an inseparable form lock is produced in the circumferential direction between the tubular section and the component. The joint is exactly repeatable, and can be made with an economical procedure, simultaneously and in a single tool, by any kind of shaping operation on the tubular section outside of the joint area. No additional connecting means are needed, so that the number of parts for producing the joint is minimal.

The invention is further explained as follows with the aid of several embodiments represented in the drawings.

### BRIEF DESCRIPTION OF THE DRAWINGS

FIG. 1 shows a lateral longitudinal section of a joint made according to the invention, with a polygonal cross section of the component and tubular section outside of the narrowing of the cross section,

FIG. 2 shows in a lateral longitudinal section a joint made according to the invention with a narrowing of the cross section produced by a punching action.

### DETAILED DESCRIPTION OF THE DRAWINGS

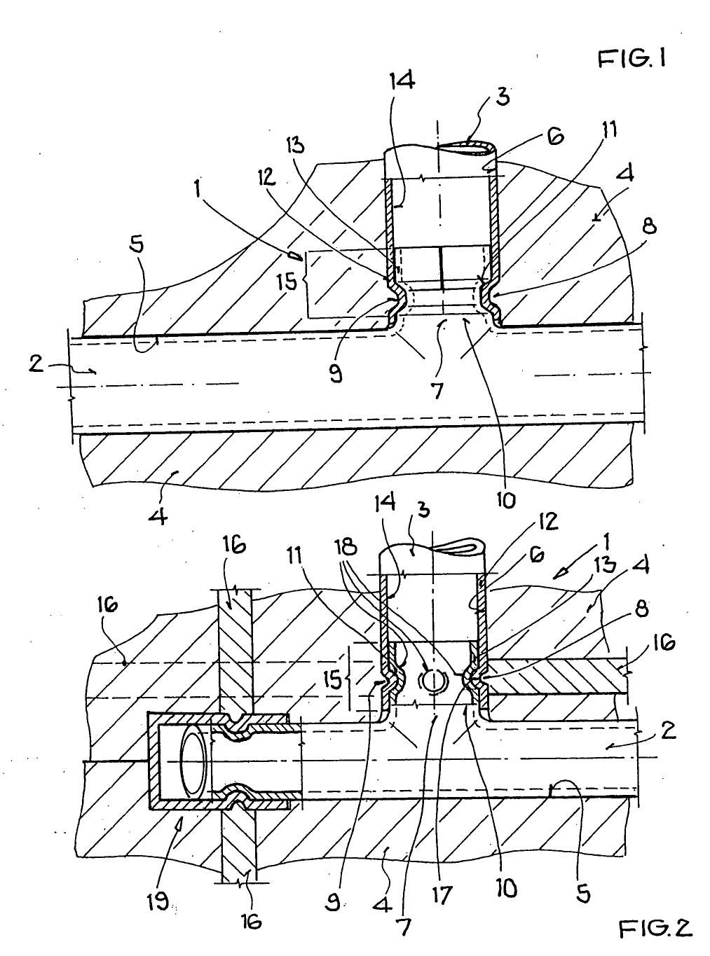

In FIG. 1 a joint 1 between a circumferentially continuous tubular section 2 and a hollow component 3 is represented. The tubular section 2 and the component 3 are placed in a divided high internal pressure forming tool 4, the tubular section 2 being arranged in the main part of the tool cavity 5 and the component 3 in a branch 6 issuing radially from this main member. The branch 6 has an annular bead 8 near its open end 7, which reaches into the die cavity 5 of the branch 6. The tubular section 2 can have any desired cross section, while the component 3 can likewise have a circumferentially continuous tubular section, although an open configuration of component 3 with a longitudinal slot and/or with holes and the like is possible. The tubular component 3 has furthermore a cross-sectional constriction 9 which is formed preferably mechanically by way of a punch forced into it. Thereafter it is placed into the branch 6 of the cavity 5, in which case the cavity 5 follows the shape of component 3, at least as regards the cross-sectional constriction 9. The component 3 thus lies in the installed state in tool 4 at least in a shape equal to that of the annular bead 8. A fluidic high-pressure is then produced in the tubular section 2, so that it expands and comes in contact with the main part of the cavity 5. At the location of the branch 6 the tubular section material is expanded into it by the high internal pressure and expands the component 3 inwardly, so that a nipple 10 is formed. As the process of the expansion continues the undercut surfaces 11 of the cross-sectional constriction 9 of component 3 are gripped by the nipple 10 in formation, and the nipple 10 is pressed, at least at the point of the cross-sectional constriction, conformingly against the inside 14 of component 3, so that the tubular section 2 is joined to component 3 unreleasably in the axial direction of component 3 by the form lock thus achieved. The walls 12 and 13 of the tubular section 2 and component 3 thus form a common indentation at the point of the cross-sectional constriction 9. Although the branch 6 can be formed over the entire overlapping junction area 15 of tubular section 2 and component 3 in a cross-sectional shape departing from a circular shape, in the present embodiment this is the case only outside of the annular bead 8 on the main part of the side facing away from the cavity 5. Thus the branch 6 is given the shape of a polygon. On account of the high internal pressure the walls 12 and 13 of the tubular section 2 and component 3 are expanded there and pressed, faithfully in shape and contour, against the wall of the branch 6, so that a junction secure against rotation is formed between component 3 and the tubular section 2.

As an alternative to this embodiment, the tubular section 2 can have the nipple 10 prior to connection with component 3. If component 3 likewise is in the form of a tubular section it is simply placed on the nipple 10 for positioning on the tubular section 2 before the form lock is made. The component 3 in that case still has no cross-sectional constriction 9.

It is conceivable also in the case of quick methods of assembly that the component 3 is configured as an initially open tubular section, in which case this tubular section wraps around a hollow space over at least 180°. Before the formation of the form lock, the component 3 is then flexed resiliently back at the edges of the opening for positioning on the tubular section to be joined, and it is placed on the tubular section 2 and held there clamp-like as the edges of the opening spring back.

In this joining situation or in the plug-in position, the tubular section 2 and the component 3 are placed together into the high internal pressure forming tool 4 and expanded by high internal pressure; their walls 12, 13 are pressed conformingly against the contours of bead 8 with formation of the indentation and the undercut surfaces 11, and against the wall of branch 6 provided with an other-than-round cross section for the achievement of security against rotation.

Likewise it is possible that the component 3 may have the cross-sectional constriction 9 before it is placed onto the tubular section 2, so that, when the assembly of component 3 and tubular section 2 is placed into the forming tool 4, the entire assembly is at once fixed in place by the form-fitting engagement of the annular bead 8 in the constriction 9 of component 3. Then, due to the high internal pressure, at first only the tubular section conforms to the cross-sectional constriction 9 of component 3 by being urged against the bead 9, and then the tubular section 2 and component 3 are pressed conformingly against the branch wall for security against rotation.

Component 3 can also be arranged in the main part of cavity 5 of the forming tool 4 instead of in the branch 6. In this case the annular bead 8 should be formed correspondingly at the main part of the cavity 5. Likewise, as regards its cross section it would have to depart from a circular shape in the meaning of the invention. It is possible in this case to omit entirely the branch 6 and with it the nipple 10.

In an additional variant according to FIG. 2, the tubular section 2 assembled with component 3 in the forming tool 4 is expanded by high internal pressure to form a press fit between component 3 and tubular section 2, after which the walls 12, 13, engage conformingly with the branch wall, which may be oval. Then the walls 12 and 13 of tubular section 2 and component 3, lying frictionally against one another, are forced by the cooperation of a plurality of punches 16 with the high internal pressure to form the constriction locally or circumferentially. This variant is especially reliable, since the stretching edges of the bead 8 which is formed by the face 17 of the punch 16, are developed only after the walls 12, 13, develop at the branch wall. By cooperation with the internal pressure the face 17 is formed with great precision on the component 3 and on the tubular section 2, so that no production inaccuracies develop which would have an undesirable influence on the particular purpose for which the assembly is to be used. Moreover, on account of the internal pressure urging outwardly, no depressions are formed on the assembly, so that its basic shape and statics and likewise flexural rigidity are unimpaired. The flow of the material of the walls 12 and 13 on the front side can be controlled by timely withdrawal of the punch 16 and/or by appropriate lowering of the high pressure, such that no local thinning occurs, which as a scored line would result in a quick collapse of the assembly if stresses are encountered. In case of one or more local indentations in which no annular beads, but locally limited beads are used, negative forms of bulges 18 are formed by each application of pressure to the assembly, creating a form lock not only axially but also radially, so that security against rotation is already provided. This, however, is further enhanced if, as explained above, the assembly is given a non-rotationally symmetrical cross section by the application of shape-matching pressure against the branch wall of non-circular shape. Even in the case of the described variant according to FIG. 2, the possibility of the joint 1 is not limited to the nipple 10. The component 3 can also include the tubular section 2 as a kind of prolongation of the lengthwise extending portion of the tubular section 2, while component 3 can be configured in a pot shape 19 as it is here, for example.

To further increase the inseparable characteristic of the joint 1, it is conceivable, before the indentation is made in the junction area 15 between the tubular section 2 and the component 3, to apply an adhesive, activating the adhesive preferably by heat treatment after the indentation is made. Alternatively, before forming the indentation of component 3 and tubular section 2, to coat at least one of its walls 12 and 13 with solder, while after the double-walled indentation has been made, and the component 3 and the tubular section 2 have been completed, to solder them together by heat treating the solder.

Furthermore, it is possible in an advantageous manner, before the indentation has been made in the junction area 15, to insert a damping material, so that undesired setting up of vibrations in assembly can be counteracted, which can have an advantageous effect on the damping of the echo in a structure, for example in the body of a motor vehicle which is attached to the assembly.

1-11. (canceled)

12. A method for making a joint between an initially closed tubular member and a hollow component, comprising:
using a fluid under high pressure acting on walls of the tubular member and component in a joint area to form at least one common indentation on the walls of the tubular member and of the component; and
using the high-pressure fluid to widen the tubular member in the joint area to form a non-circular cross-section.

13. The method according to claim 12, wherein the component is tubular, the method further comprising assembling the component with the tubular member before the formation of the joint to position the component on the tubular member.

14. The method according to claim 12, further comprising:
the component as an initially open tubular section, which surrounds a hollow space over at least 180°; and
turning up the component prior to the formation of the joint elastically at the edges of the opening for positioning on the tubular member; and
placing the component on the tubular member with a springing back of the edges of the opening.

15. The method according to claim 14, further comprising expanding the tubular member and the component together in the joining position and pressing the walls of the tubular member and the component to shape against a bead which is formed in a high internal pressure forming tool that surrounds the tubular member and the component.

16. The method according to claim 14,
narrowing the cross-section of the tubular section of the component;
placing the tubular section of the component in an high internal pressure forming tool at least at the cross-sectional narrowing; and
pressing the tubular member using the high pressure fluid conformingly against the inside of the component.

17. The method according to claim 16, wherein the step of narrowing the cross-section of the tubular section of the component includes narrowing the cross-section of the tubular section of the component mechanically with a punch.

18. The method according to claim 14, further comprising:
expanding the loosely assembled tubular member and the component with the high pressure fluid to form a press fit between the component and tubular member;
using the high pressure fluid to force the walls of the tubular member and of the component against at least one punch arranged in a high internal pressure forming tool, to form an indentation.

19. The method according to claim 16, further comprising using the high pressure fluid to form a nipple from the tubular member, and joining the nipple to the component.

20. The method according to claim 19,
placing the cross-sectional narrowing of the component in a branch of the high internal pressure forming tool, wherein the branch is of the same shape at the place of the cross-sectional narrowing with the component when the component is inserted into the forming tool; and
using the high pressure fluid to expand the tubular member and the component into the branch, undercut surfaces of the cross-sectional narrowing of the component being caught from behind by the nipple that is forming.

21. The method according to claim 20, further comprising placing adhesive between the tubular member and the component before the formation of the indentation, and activating the adhesive ability of the adhesive after the formation of the indentation.

22. The method according to claim 20, further comprising placing solder between the tubular member and the component before the formation of the indentation, and attaching the tubular member and the component by heating the solder after the formation of the indentation.

23. The method according to claim 20, placing a damping material between the tubular member and the component before the formation of the indentation.

24. The method according to claim 12, further comprising expanding the tubular member and the component together in the joining position and pressing the walls of the tubular member and the component to shape against a bead which is formed in a high internal pressure forming tool that surrounds the tubular member and the component.

25. The method according to claim 12,
narrowing the cross-section of the tubular section of the component;
placing the tubular section of the component in an high internal pressure forming tool at least at the cross-sectional narrowing; and
pressing the tubular member using the high pressure fluid conformingly against the inside of the component.

26. The method according to claim 25, wherein the step of narrowing the cross-section of the tubular section of the component includes narrowing the cross-section of the tubular section of the component mechanically with a punch.

27. The method according to claim 13, further comprising:
expanding the loosely assembled tubular member and the component with the high pressure fluid to form a press fit between the component and tubular member;
using the high pressure fluid to force the walls of the tubular member and of the component against at least one punch arranged in a high internal pressure forming tool, to form an indentation.

28. The method according to claim 12, further comprising placing adhesive between the tubular member and the component before the formation of the indentation, and activating the adhesive ability of the adhesive after the formation of the indentation.

29. The method according to claim 12, further comprising placing solder between the tubular member and the component before the formation of the indentation, and attaching the tubular member and the component by heating the solder after the formation of the indentation.

30. The method according to claim 12, placing a damping material between the tubular member and the component before the formation of the indentation.
